(19) United States
(12) Patent Application Publication
(10) Pub. No.: US 2011/0101783 A1
(43) Pub. Date: May 5, 2011

(54) Electrical Power Distribution System and Method Thereof

(75) Inventor: Peter F. Hoffman, Avon, OH (US)

(73) Assignee: EVEREADY BATTERY COMPANY, INC., St. Louis, MO (US)

(21) Appl. No.: 12/987,476

(22) Filed: Jan. 10, 2011

Related U.S. Application Data
(63) Continuation of application No. PCT/US2009/004341, filed on Jul. 27, 2009.
(60) Provisional application No. 61/084,059, filed on Jul. 28, 2008.

(51) Int. Cl. H02J 3/00; H01F 38/00

(52) U.S. Cl. 307/72; 307/104

(57) ABSTRACT

An electrical power distribution system and method are provided, wherein the system includes a primary generator and a secondary harvester. The primary generator includes a primary coil configured to emit an electromagnetic field when an electrical power is supplied to the primary coil, and a first communication device configured to communicate a signal. The secondary harvester includes a secondary coil configured to supply an electrical power when receiving the emitted electromagnetic field, and a second communication device configured to communicate the signal, such that the first and second communication devices communicate the signal independent from the emitted electromagnetic field.

### RELATED APPLICATIONS

This application is a continuation of International Application PCT/US2009/004341, filed Jul. 27, 2009, which claimed the benefit of U.S. provisional application No. 61/084,059, filed Jul. 28, 2008.

### FIELD OF THE INVENTION

The present invention generally relates to an electrical power distribution system and method thereof, and more particularly, to an electrical power distribution system and method that controls at least one distribution characteristic of supplied electrical power.

### BACKGROUND OF THE INVENTION

Generally, the distribution of electrical power requires an electrical contact between a power source and a load, wherein the electrical connection is formed by one or more electrical conductors. For example, standard wall outlets in the United Sates are adapted to receive two or three metal conductors from a standard plug, such that the plug's metal conductors are received by the outlet and come in contact with “live” corresponding electrical conductors. The outlet is “live” in that the conductors behind the face plate having the receptacles are supplied with electrical power, and any electrical conducting element that is inserted into the receptacle of the outlet can draw the electrical power. Thus, there are limitations as to the environment where the plug can be received by the outlet due to the requirement to have such an electrical connection.

Further, fuses or circuit breakers can be used to break the circuit that is supplying electrical power under certain circumstances. Thus, any break in the circuit results in the electrical power not being supplied to a load. The fuse or circuit breaker can be used to prevent the wiring from overheating due to a fault condition by completely breaking the circuit and stopping the supply of electrical power, but are typically not configured to limit the flow of electrical power in other ways.

Typically, electrical power is supplied to a building structure from the power company having a predetermined set of distribution characteristics (e.g., one hundred twenty volts/two hundred forty volts (120V/240V)) and 60 hertz (60 Hz)). Generally, the electrical power is continued to be distributed throughout the building structure having the same electrical power characteristics and until the electrical power is supplied to the load, at which time the load can either consume the supplied power as delivered (e.g., an alternating current (AC) incandescent light bulb), or alter the electrical power to a desired form for use by the load (e.g., a load that has an adaptive wall plug). Additionally, the load may have subsystems that require both one hundred twenty volts (120V) and some other form of electrical power. Since the electrical power is being distributed throughout the building structure having the same electrical power characteristics, there are typically, limited points of monitoring the electrical power distribution, such as circuit breakers and ground fault interrupts (GFI).

### SUMMARY OF THE INVENTION

According to one aspect of the present invention, an electrical power distribution system includes a primary generator and a secondary harvester. The primary generator includes a primary coil configured to emit an electromagnetic field when an electrical power is supplied to the primary coil, and a first communication device configured to communicate a signal. A secondary harvester includes a secondary coil configured to supply an electrical power when receiving the emitted electromagnetic field, and a second communication device configured to communicate the signal, such that the first and second communication devices communicate the signal independent from the emitted electromagnetic field.

According to another aspect of the present invention, an electrical power distribution system includes a primary generator and a secondary harvester. A primary generator includes a primary coil configured to emit an electromagnetic field when an electrical power is supplied to the primary coil, and a first communication device configured to communicate a signal. The secondary harvester includes a secondary coil configured to supply an electrical power when receiving the emitted electromagnetic field, and a second communication device configured to transmit the signal such that the first and second communication devices wirelessly communicate the signal as to power requirements of a load independent of the emitted electromagnetic field.

According to yet another aspect of the present invention, an electrical power distribution system includes an attachment device and a controller. The attachment device is configured to receive a first electrical power and supply a second electrical power, wherein the supplied second electrical power is based upon load requirements communicated from at least one load to the attachment device. The controller is in communication with the attachment device and is configured to command the attachment device to supply the second electrical power.

According to another aspect of the present invention, an electrical power distribution system includes a plurality of attachment devices and a system controller. At least a portion of the plurality of attachment devices are configured to receive a first electrical power and supply a second electrical power that is based upon load requirements communicated from a first load to the at least a portion of the plurality of attachment devices. The system controller is in communication with at least a portion of the plurality of attachment devices, and is configured to control the supply of the second electrical power.

According to yet another aspect of the present invention, an electrical power distribution system includes a primary generator, a secondary harvester, and a controller. A primary generator is configured to emit an electromagnetic field when a first electrical power is supplied to the primary generator. The secondary harvester is configured to supply a second electrical power when proximate the primary generator and the electromagnetic field emitted from the primary generator is received. The controller is in communication with one of the primary generator and the secondary harvester, and configured to control the supply of the second electrical power by the secondary harvester.

According to another aspect of the present invention, a method of distributing electrical power includes the steps of receiving a first electrical power having a first distribution characteristic by a converter, and altering the first distribution characteristic of the first electrical power by the converter. The method further includes the steps of supplying a second electrical power having a second distribution characteristic different than the first distribution characteristic from the converter, and supplying a third electrical power having a third distribution characteristic different than the first and second distribution characteristic from the converter.

According to yet another aspect of the present invention, a method of distributing electrical power includes the steps of receiving a first electrical power supplied at a first frequency by a converter and altering the first frequency to a second frequency and a third frequency by the converter. The method further includes the steps of supplying a second electrical power having the second frequency from the converter, and supplying a third electrical power having the third frequency from the converter.

According to another aspect of the present invention, an extension cord includes a secondary harvester, and at least one primary generator in electrical communication with the secondary harvester by at least one electrical conductor. The secondary harvester includes a secondary coil configured to supply an electrical power when a first electromagnetic field is received, and a secondary communication device configured to communicate a signal. The at least one primary generator includes a primary coil configured to emit a second electromagnetic field based upon the electrical power supplied the by secondary harvester, and a primary communication device configured to communicate the signal as to the electrical power requirements of at least one load.

According to another aspect of the present invention, a method of distributing electrical power includes the steps of emitting an electromagnetic field by a primary generator when a primary generator receives an electrical power, receiving the emitted electromagnetic field by a secondary harvester, receiving electrical power requirements of at least one load by the secondary harvester, and selectively supplying the electrical power by the secondary harvester to the at least one load.

According to yet another aspect of the present invention, an adaptor includes a secondary harvester configured to supply an electrical power when an electromagnetic field is received, and a plug interface adapted to receive at least two electrical conductors, such that the electrical power supplied by the secondary harvester is propagated over the at least two electrical conductors.

According to another aspect of the present invention, an adaptor includes a plug interface adapted to receive at least two electrical conductors that propagate electrical power, and a primary generator configured to emit an electromagnetic field when the primary generator receives the electrical power that is propagated over the at least two electrical conductors.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is a block diagram illustrating an electrical power distribution system, in accordance with one embodiment of the present invention;

FIG. 2 is a block diagram of a primary generator and a secondary harvester of an electrical power distribution system, in accordance with one embodiment of the present invention;

FIG. 3 is a block diagram illustrating an electrical power distribution system, in accordance with another embodiment of the present invention;

FIG. 4 is an environmental view illustrating a control interface for controlling a supply of electrical power in an electrical power distribution system, in accordance with one embodiment of the present invention;

FIG. 5 is a block diagram illustrating an extension cord in an electrical power distribution system, in accordance with one embodiment of the present invention;

FIGS. 6A-6D are flow charts illustrating a method of distributing electrical power, in accordance with one embodiment of the present invention;

FIG. 7A is a block diagram illustrating an electrical power distribution system having an adapter, in accordance with one embodiment of the present invention;

FIG. 7B is a block diagram of an electrical power distribution system having an adaptor, in accordance with another embodiment of the present invention;

FIG. 8A is a front-side perspective view of a secondary harvester in an electrical power distribution system, in accordance with one embodiment of the present invention;

FIG. 8B is a cross-sectional view of the secondary harvester of FIG. 8A across the line B-B;

FIG. 8C is an exploded cross-section plan view of a primary generator and a secondary harvester in an electrical power distribution system, in accordance with one embodiment of the present invention;

FIG. 9A is a front perspective view of a secondary harvester in an electrical power distribution system, in accordance with another embodiment of the present invention;

FIG. 9B is a front perspective view of a primary generator in an electrical power distribution system, in accordance with another embodiment of the present invention;

FIG. 9C is a perspective view of the secondary harvester of FIG. 9A proximate to the primary generator of FIG. 9B, in accordance with one embodiment of the present invention; and

FIG. 9D is a perspective view of the secondary harvester of FIG. 9A proximate to a primary generator, in accordance with another embodiment of the present invention.

### DETAILED DESCRIPTION OF PREFERRED EMBODIMENTS

Before describing in detail embodiments that are in accordance with the present invention, it should be observed that the embodiments include combinations of method steps and apparatus components related to an electrical power distribution system and method thereof. Accordingly, the apparatus components and method steps have been represented, where appropriate, by conventional symbols in the drawings, showing only those specific details that are pertinent to understanding the embodiments of the present invention so as not to obscure the disclosure with details that will be readily apparent to those of ordinary skill in the art having the benefit of the description herein. Further, like reference characters in the description and drawings represent like elements.

In this document, relational terms, such as first and second, top and bottom, and the like, may be used to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

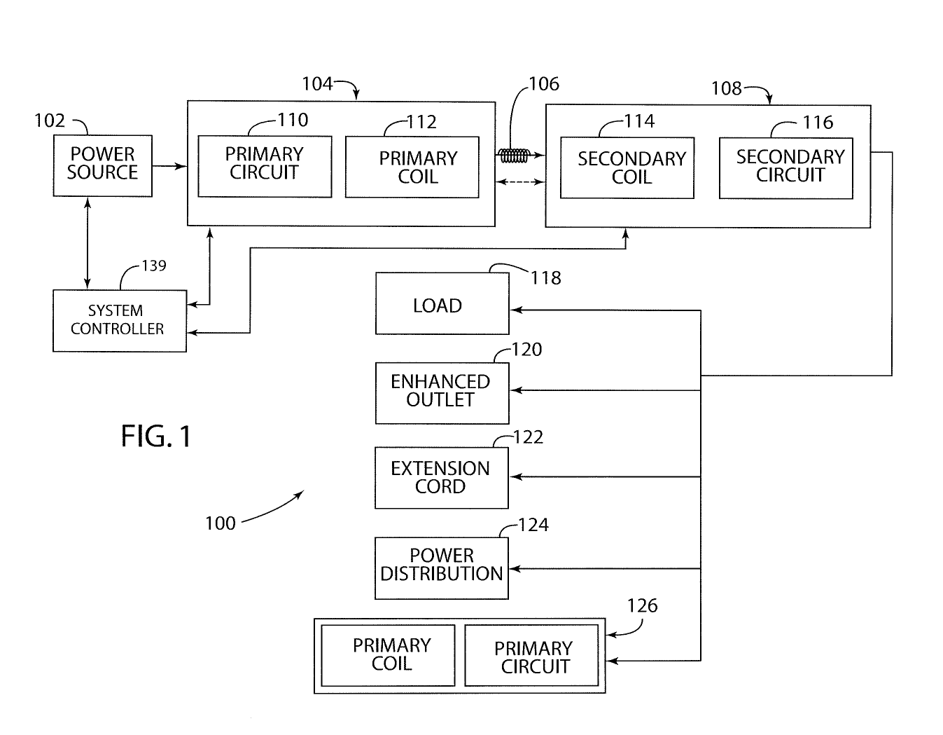

In regards to FIG. 1, an electrical power distribution system is generally shown at reference identifier 100. The electrical power distribution system 100 includes a power source 102 that supplies an electrical power, and a primary generator generally indicated at 104, that is in electrical communication with the power source 102, according to one embodiment. Typically, the primary generator 104 emits an electromagnetic field 106 when the primary generator 104 receives the electrical power supplied from the power source 102. The electrical power distribution system 100 can further include a secondary harvester generally indicated at 108 that is configured to supply an electrical power when proximate the primary generator 104, such that the secondary harvester 108 supplies an electrical power that is based upon the electromagnetic field 106 emitted from the primary generator 104, as described in greater detail herein.

Typically, the electrical power distribution system 100 can transmit or communicate electrical power through the system 100 having various distribution characteristics, wherein the electrical power can be transmitted between the power source 102 and a load 118 over a hard-wire connection (e.g., copper wire) or wirelessly (i.e., inductive connection including the primary generator 104 and the secondary harvester 108). Additionally, at points of distribution, wherein the distribution characteristics of the electrical power can be altered, the electrical power distribution system 100 can include intelligence (e.g., a controller or a processor) for monitoring the electrical power distribution, altering at least one distribution characteristic of the supplied electrical power, communicating with other components or devices in the electrical power distribution system 100, the like, or a combination thereof. According to one embodiment, the distribution characteristics of the electrical power include any characteristic or form of the electrical power during distribution, such as, but not limited to, alternating current (AC), direct current (DC), voltage potential, electrical current, frequency, being distributed at a substantially constant voltage potential, being distributed at a substantially constant voltage potential, being distributed to a substantially constant electrical current, pulse width modulated (PWM), pulse frequency modulated (PFM), the like, or a combination thereof. Thus, the electrical power distribution system 100 can be configured to distribute or supply electrical power having different distribution characteristics at different points in the system 100, while intelligently monitoring the distribution of the electrical power and communicating information between components of the system 100 as to the distribution of the electrical power.

According to one embodiment, the primary generator 104 includes a primary circuit 110 and a primary coil 112, and the secondary harvester 108 includes a secondary coil 114 and a secondary circuit 116. Typically, the secondary harvester 108 supplies the electrical power to the load 118 that is generated from the reception of the electromagnetic field 106 emitted from the primary generator 104. In such an embodiment, the electrical power distribution system 100 includes a contactless, inductive point of distribution, which enables the load 118 to receive electrical power from the power source 102 without forming a physical, electrical contact between two electrically conductive devices (e.g., without utilizing a standard outlet and plug apparatus).

By way of explanation and not limitation, the load 118 can be, but is not limited to, a device that utilizes the received electrical power to operate, charge a rechargeable power source that is internal to the load 118, or a combination thereof. Additionally or alternatively, the load 118 can also be, but not limited to, an enhanced outlet 120, an extension cord generally indicated at 122, a power distributor 124, an induction device generally indicated at 126 having a primary coil 112 and a primary circuit 110 that emits the electromagnetic field 106, the like, or a combination thereof. It should be appreciated by those skilled in the art that the description of one or more exemplary embodiments contained herein as to the load 118 are not limited to utilizing only the load 118, but are instead described utilizing load 118 for purposes of explanation.

According to one embodiment, the power source 102 is a point-of-entry for electrical power into a building structure, which in the United States, the electrical power at such a point-of-entry typically has distribution characteristics including a voltage potential of one hundred twenty volts/two hundred forty volts (120V/240V) and a frequency of sixty Hertz (60 Hz). In such an embodiment, the electrical power distribution system 100 is a power distribution system within a building structure or dwelling, wherein electrical power can be supplied having a desired distribution characteristic, such as, but not limited to, a desired voltage potential or form (i.e., AC or DC). Thus, the electrical power can be transmitted or propagated throughout the building structure (i.e., the system 100) having various different distribution characteristics, without regard as to how the electrical power was supplied to the building structure from the power company.

According to one embodiment, the secondary harvester 108 communicates with the primary generator 104 to form a local control network. Thus, data can be communicated between the secondary harvester 108 and the primary generator 104, such as, but not limited to, the type of load 118,120,122,124,126 that is electrically connected to the secondary harvester 108, the power requirements of the load 118, the like or a combination thereof. The primary generator 104 can communicate with the secondary harvester 108 utilizing a hard-wire connection or a wireless connection. The local control network can be the communication between a source of electrical power (e.g., the primary generator, 104) and one or more loads 118 at a point of distribution, which typically includes utilizing the secondary harvester 108, according to one embodiment. For purposes of explanation and not limitation, the secondary harvester 108 can communicate with the primary generator 104 utilizing a wireless connection that includes an inductive channel using amplitude modulation (AM) to encode a signal included in the electromagnetic field 106, a signal independent of the electromagnetic filed 106, such as, but not limited to, a wireless radio frequency (RF) communication signal, including near field and/or far field, RFID, a ZIGBEE™ connection, a BLUETOOTH™ connection, a local area network (LAN) connection, a Wi-Fi connection, optical communication with light having a visible and/or non-visible wavelength, the like, or a combination thereof.

Alternatively, the primary generator 104 and the secondary harvester 108 can communicate utilizing a hard-wire connection, such that the signal is transmitted over the hard-wire connection independent at the electromagnetic field 106. According to yet another embodiment, the primary generator 104 can communicate with the secondary harvester 108 utilizing a mechanical or physical connection. By way of explanation and not limitation the mechanical connection can be a key and an interpretation of the key, such as a brail dot pattern integrated on a surface of the secondary harvester 108 that is recognized (e.g., physically contract, obstruct an illumination path, etc.) by the primary generator 104.

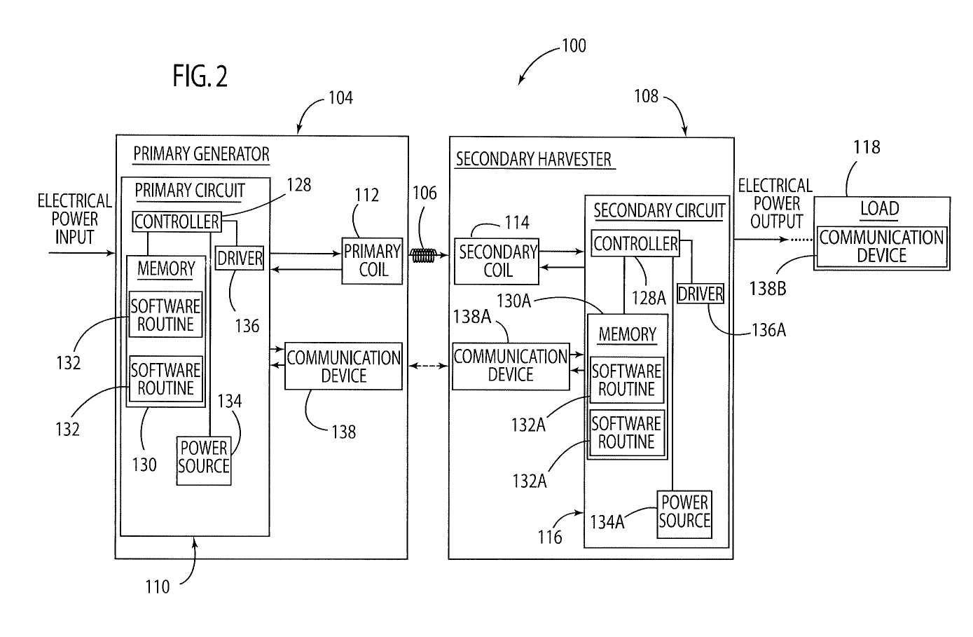

With respect to FIG. 2, the hardware circuitry 110 of the primary generator 104 includes a controller 128, a memory device 130 that stores one or more executable software routines 132, a power source 134, and a driver 136, according to one embodiment. Further, the primary generator 104 can include a communication device 138 for communicating with the secondary harvester 108. Typically, the communication device 138 communicates the received data to the controller 128, such that the controller 128 can control the supply of electrical power, such as, but not limited to, by altering the electromagnetic field 106 emitted by the primary coil 112. Additionally, the secondary harvester 108 can include the secondary circuit 116 having a controller 128A, a memory 130A that stores one or more executable software routines 132A, a power source 134A, and a driver 136A. Further, the secondary harvester 108 can include a communication device 138A, which is used to communicate with the primary generator 104 and communicates data to the controller 128A. According to one embodiment, the load 118 can include a communication device 138B for communicating with the secondary harvester 108. Typically, the communication device 138A communicates the received data to the controller 128A, such that the controller 128A can control the supply of electrical power.

The communication between the secondary harvester 108 and the load 118 can utilize a wireless signal or a signal that is transmitted over an electrical conductive wire, such as the electrical conductive wire that is utilized for propagating the electrical power from the secondary harvester 108 to the load 118 or a different electrical conductive wire that electrically connects the secondary harvester 108 to the load 118. According to one embodiment, when components or devices of the electrical power distribution system 100 are in communication with one another, the component or device can be configured to transmit a signal, receive a signal, or a combination thereof.

According to one embodiment, the primary generator 104 and the secondary harvester 108 can communicate, such that the primary generator 104 can emit the electromagnetic field 106 based upon the electrical power that the secondary harvester 108 is scheduled to supply to the load 118 (e.g., the amount of electrical power requested by the load 118 via the communication connection between the secondary harvester 108 and the load 118). In such an embodiment, the primary generator 104 emits the electromagnetic field 106 having a sufficient strength or magnetic flux for the secondary harvester 108 to convert the received electromagnetic field 106 to the desired electrical power that is supplied to the load 118. The information communicated in the signal as to the electrical power requirements of the load 118 can additionally or alternatively include information as to the distribution characteristics of the electrical power supplied from the secondary harvester 108 to the load 118 (e.g., voltage potential, electrical current, frequency, etc.), planned load requirements, the like or a combination thereof.

For purposes of explanation and not limitation, the planned load requirement can be where the load 118 is a rechargeable device (e.g., a cellular telephone having rechargeable power source), and it is known at the time the primary generator 104 and secondary harvester 108 are located proximate to one another that the electrical power desired by the load 118 will vary over a time period, such as based upon the recharging routine of the load 118. In such an embodiment, it is known that the load 118 is to be supplied with a greater amount of electrical power during a first period of time (e.g., a first charging period of a rechargeable lithium-ion battery), when compared to the amount of electrical power supplied during a second period of time (e.g., a parasitic amount of electrical power). Thus, the information as to the charging routine of the load 118 can be communicated to the primary generator 104 or the secondary harvester 108, wherein the local controller 128 or 128A, respectively, can determine if an adequate amount of electrical power is available from the power source 102 for the entire charging routine of the load 118. Additionally, or alternatively, the information as to the recharging routine of the load 118 can be communicated to a system controller 139 via the primary generator 104, the secondary harvester 108, or combination thereof, such that the system controller 139 can determine if the power source 102 can supply an adequate amount of electrical power to the load 118.

Without regard to whether the electrical power supplied to the load 118 is constant or varies, the secondary harvester 108 can communicate the information as to the electrical power requirements of the load 118 to the primary generator 104, the secondary harvester 108, the system controller 139, or a combination thereof, prior to the electrical power being supplied to ensure an adequate amount of electrical power can be supplied by the power source 102. Thus, the primary generator 104, the secondary harvester 108, or a combination thereof, can determine if the primary generator 104 can adequately emit the electromagnetic field 106 to supply the requested electrical power to the load 118 (e.g., local control), wherein the system controller 139 can determine if the electrical power distribution system 100 can adequately supply the requested electrical power to the one more loads 118.

The primary generator 104 and secondary harvester 108 can communicate other data, such as, but not limited to, a request to disconnect the power, according to one embodiment. Thus, the local controllers 128,128A, the system controller 139, or a combination thereof, can determine that the amount of electrical power requested or drawn by the load exceeds an amount that can be supplied by the power source 102 or a predetermined electrical power threshold, as described in greater detail below. In such an embodiment, the local controllers 128,128A, the system controller 139, or a combination thereof, can replicate a fuse or a circuit breaker to disconnect or discontinue the supply of electrical power to the load 118. Additionally or alternatively, the local controllers 128,128A, the system controller 139, or a combination thereof, can selectively control the supply of the electrical power.

According to one embodiment, the communication device 138 of the primary generator 104 can be used to detect when the secondary harvester 108 is proximate to the primary generator 104, such that the primary generator 104 only emits the electromagnetic field 106 when the secondary harvester 108 is detected. The communication devices 138,138A can be used to communicate with one another in order for the primary generator 104 to detect the secondary harvester 108, such as, but not limited to, using a radio frequency identification (RFID) signal. In such an embodiment, the power source 102 continuously supplies electrical power to the primary generator 104, and the primary generator 104 periodically transmits a signal to the secondary harvester 108, such that if the secondary harvester 108 is proximate to the primary generator 104, then the secondary harvester 108 receives the transmitted signal and responds by transmitting a signal to primary generator 104. When the primary generator 104 receives the response signal, the primary generator 104 emits the electromagnetic filed 106. However, if the primary generator 104 does not receive the responsive signal, the primary generator 104 continues to not emit the electromagnetic field 106. Typically the periodic signal transmitted by the primary harvester 104 is configured to supply an electrical power to the secondary harvester 108, such that the secondary harvester 108 receives an adequate amount of electrical power to power to secondary harvester 108 in order to transmit the response signal to the primary generator 104.

Additionally, the first and second communication devices 138,138A can communicate with the system controller 139, such that the system controller 139 can control the electrical power distribution over the entire electrical power distribution system 100 based upon the information communicated at the point of distribution between the first and second communication devices 138,138A, as described in greater detail below. The system controller 139 can be in communication with the first and second communication devices 138,138A utilizing a hard-wire connection, a wireless connection, or a combination thereof.

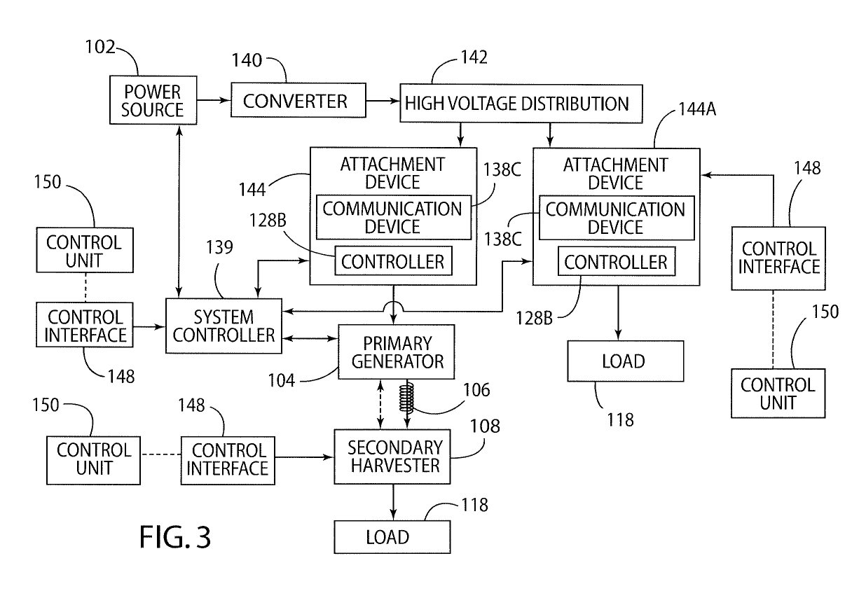

In regards to FIG. 3, the electrical power distribution system 100 can be in a building structure, wherein the electrical power is distributed at a higher voltage potential than a voltage potential of an electrical power supplied by the power company to the power source 102 (i.e., the point-of-entry), according to one embodiment. Typically, in the United States, the electrical power that is ultimately supplied to a building structure has distribution characteristics of a voltage potential of one hundred twenty volts/two hundred forty volts (120V/240V) and a frequency of sixty Hertz (60 Hz). The electrical power distribution system 100 can be configured to increase the voltage potential, or alter one or more other distribution characteristics of the electrical power, in order for the electrical power to be distributed throughout the building structure. In such an embodiment, the power source 102 can be in electrical communication with a convertor 140, wherein the converter alters at least one distribution characteristic of the electrical power. According to one embodiment, the converter 140 increases the voltage potential of the electrical power received from the power source 102, such that the voltage potential of the electrical power distributed through at least a portion of the electrical power distribution system 100 is greater than one hundred twenty volts (120V). Alternately, the power company can adjust its delivery and distribution network to supply electrical power having different distribution characteristics such as, but not limited to, distributing electrical power at a higher voltage.

For purposes of explanation and not limitation, when the power source 102 is the point-of-entry of the building structure for receiving electrical power at a first voltage potential from the power company (e.g., one hundred twenty volts (120V)), the converter 140 can increase the voltage potential, so that the electrical power can be distributed at a second voltage potential by at least one high voltage distribution bus 142, wherein the second voltage potential is greater than the first voltage potential. According to one exemplary embodiment, the second voltage potential of the electrical power is approximately four hundred eighty volts (480V), i.e. high voltage. By distributing electrical power at a voltage potential greater than one hundred twenty volts (120V), the gauge of the wire used to transmit the electrical power can be increased, which results in less electrically conductive material (e.g., copper wire) being used to transmit the electrical power, when compared to the amount of electrically conductive material typically used in a building structure to distribute electrical power having a voltage potential of one hundred twenty volts (120V).

For example a common size branch circuit used in the US for residential electrical receptacles (outlets) and lighting is 20 A, 120VAC. This branch circuit is capable of nominally supplying a maximum of 2400 W of AC power. Per the National Electric Code the wiring for said branch circuit is typically 12 gauge wire having a cross section of 3.31 mm². If the voltage of this branch circuit was increased to 240VAC the same nominal maximum power of 2400 W would only require a 10 A service that would typically use a 16 gauge wire having a cross section of 1.31 mm². Thus raising the voltage by a factor of 2 times resulted in a reduction in the amount of copper conductor usage to approximately 40% (1.31/3.31) of the original while delivering the same total electrical power. Raising the voltage by a factor of 4 (from 120VAC to 480VAC) would yield even greater copper savings for delivering the same electrical energy.

At least one attachment device 144 can be in electrical communication with the power source 102, such as through the high voltage distribution bus 142, wherein the attachment device 144 is configured to receive or draw a first electrical power (e.g., the electrical power being distributed across the high voltage distribution bus 142), and supply a second electrical power based upon local requirements communicated from at least one load 118 to the attachment device 144. Typically, the attachment device 144 includes a communication device 138C that communicates with the communication device 138B of the load 118, according to one embodiment. Further, the communication device 138C of the attachment device 144 can be in communication with the system controller 139.

According to one embodiment, as shown in FIG. 3, the primary generator 104 is in electrical communication with the attachment device 144, such that the primary generator 104 receives electrical power that is drawn from the high voltage distribution bus 142 by the attachment device 144. The primary generator 104 emits the magnetic field 104 that is received by the secondary harvester 108, such that the secondary harvester 108 can supply electrical power to the load 118. In such an embodiment, the load 118 communicates the electrical power requirements of the load 118 to the secondary harvester 108 using the communication devices 138A,138B (FIG. 2). The secondary harvester 108 can then supply the desired electrical power to the load 118 (e.g., AC, DC, desired voltage potential, desired electrical current, desired frequency, the like, or a combination thereof).

Alternatively, the secondary harvester 108 can communicate the information received from the load 118 to primary generator 104, such that the primary generator 104 can emit the electromagnetic field 106 having an adequate magnetic flux based upon the information received in regards to the amount of electrical power to be supplied to the load 118. Yet another alternative embodiment, is that the primary generator 104 communicates the information received from the load 118 to the attachment device 144, such that the attachment device 144 can supply an adequate amount of electrical power to the primary generator 104. Typically, the communication device 138C receives the information regarding the amount of electrical power to be supplied to the load 118, and a controller 128B of the attachment device 144 can control the amount of electrical power supplied by the attachment device 144. Additionally or alternatively, the information as to the electrical power requirements of the load 118 can be communicated to the system controller 139, wherein the system controller 139 commands the attachment device 144, the primary generator 104, the secondary harvester 108, another point of distribution having intelligence, or a combination thereof, to control the electrical power supplied to the load 118.

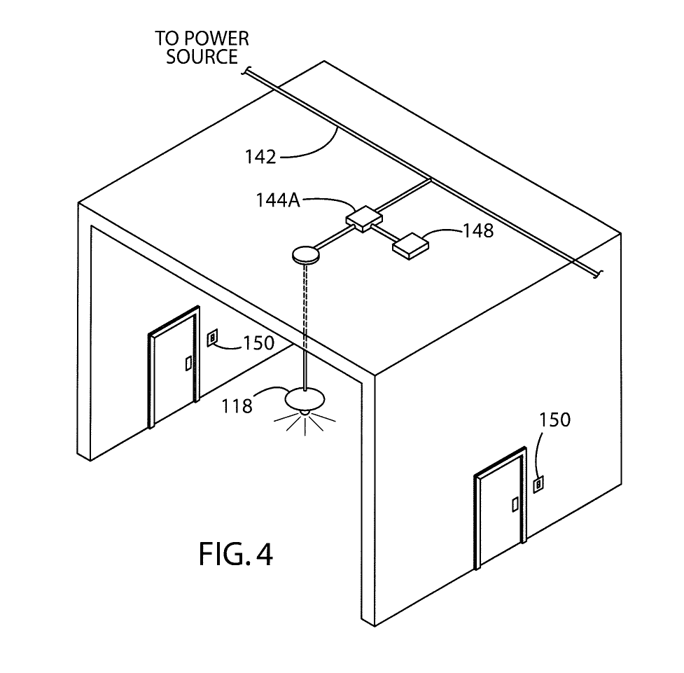

In one exemplary embodiment, as shown in both FIGS. 3 and 4, an attachment device 144A can be hard-wired to the load 118. The load 118 can communicate, via the communication device 138B of the load 118 and the communication device 138C of the attachment device 144, the electrical power requirements of the load 118 when the load 118 is initially electrically connected, or shortly thereafter, to the attachment device 144A. In such an embodiment, the load 118 may not be detachably interfaced with the attachment device (e.g., a ceiling light electrically connect to the attachment device 144 and mounted on a ceiling of a building structure). Thus, the electrical power requirements of the load 118 are typically transmitted only at the time the load is initially electrically connected to the attachment device 144A, and is not continuously transmitted.

Additionally or alternatively, the attachment device 144 can be configured to receive the first electrical power and supply the second electrical power and a third electrical power, wherein the third electrical power has at least one distribution characteristic that is different than the second electrical power. Thus, the attachment device 144 can be configured to supply electrical power to one or more loads 118, wherein at least a portion of the loads 118 have different electrical power requirements.

According to one embodiment, as shown in FIG. 3, the electrical power distribution system 100 can include at least one control interface 148 that is in communication with the secondary harvester 108, and is configured to command the secondary harvester 108. Typically, a control unit 150 is in communication with the control interface 148, such that a user of the control unit 150 can communicate a command to the control interface 148 to control the secondary harvester 108 as to the electrical power supplied by the secondary harvester 108.

According to an alternate embodiment, the control interface 148, or a second remote control interface 148A, is in communication with the attachment devices 144,144A wherein the control interface 148 is configured to command the attachment devices 144,144A to supply electrical power to the load 118. The control unit 150 is typically in communication with the control interface 148, such that the user of the control unit 150 can communicate a command to the attachment devices 144,144A, via the control interface 148, to supply electrical power to the load 118.

According to yet another alternate embodiment, the control interface 148, or an additional control interface 148, can be in communication with the system controller 139. In such an embodiment, the user of the control unit 150 can communicate a signal to the control interface 148 in order for the control interface 148 to command the system controller 139 to control the supply of electrical power to one or more loads 118 of the electrical power distribution system 100.

At least a portion of the control units 150 included in the electrical power distribution system 100 can be in wireless communication with the control interface 148, according to one embodiment. The control unit 150 can wirelessly communicate with the control interface 148 utilizing an RF signal, an IR signal, a cellular signal, the like, or a combination thereof, so long as the signal transmitted by the control unit 150 is adequately configured to be received by the control interface 148 with respect to locational relationship between the control interface 148 and the control unit 150.

According to an alternate embodiment, the control interface 148 and the control unit 150 are in communication with one another by utilizing a data wire connection, such as, but not limited to, category 5 (CAT5) wire, category six (CAT6) wire, the like, or a combination thereof. Thus, the user can activate the control unit 150, which communicates a data signal to the control interface 148 which commands the attachment device 144,144A to alter the electrical power supplied to the load 118. By utilizing the control unit 150 and the control interface 148 that are connected by the data wire connection, the amount of electrical conductive material (e.g., copper wire) is still minimized, when compared to how a standard light switch is electrically connected to a load, since the amount of electrically conductive material in the data wire connection is minimal when compared to a twelve (12) gauge wire.

According to another exemplary embodiment, wherein the control unit 150 is in wireless communication with the control interface 148, which is in communication with the system controller 139, the wireless signal can be a cellular single. In such an embodiment, the control unit 150 can be a cellular telephone, so that a user of the control unit 150 can remotely control the supply of electrical power to one or more loads 118 utilizing the system controller 139 via a cellular network. Thus, a user of the control unit 150 (e.g., cellular telephone) can command the system controller 139 to supply power (e.g., turn-on) loads 118, such as lights of the building structure that contains the electrical power distribution system 100 prior to the user being in the building structure. It should be appreciated by those skilled in the art that the loads 118 being controlled by the system controller 139 in such an embodiment can be other types of loads in addition to or alternatively than lights of the building structure.

By way of explanation and not limitation, as illustrated in FIG. 4, the control interface 148 can be in communication with an attachment device 144A that controls the supply of electrical power to a load 118, such as a ceiling light. In such an embodiment, the control unit 150 is a light switch which communicates wirelessly with the control interface 148. The control unit 150 can communicate with the control interface 148 to replicate a standard light switch in order to turn the ceiling light (load 118) on and off, or dim the ceiling light by reducing the amount of electrical power supplied to the ceiling light. The inventors of the invention appreciate that as interior lighting changes from incandescent AC powered to LED based DC powered, such a system in accordance with an aspect of the invention could be configured to serve in the transition and also allow for dimming control for either light element namely, for example pulse width modulation (PWM DC) for the LED vs. triac dimming of incandescent. By including the control unit 150 to wirelessly communicate with the control interface 148 to control the electrical power supplied by the attachment device 144A to the load 118 in the electrical power distribution system 100, the amount of electrical conductive material (e.g., copper wire) is minimized, when compared to how standard light switches are wired to a load, since the electrical conductive material does not have to connect the control unit 150 with the ceiling light.

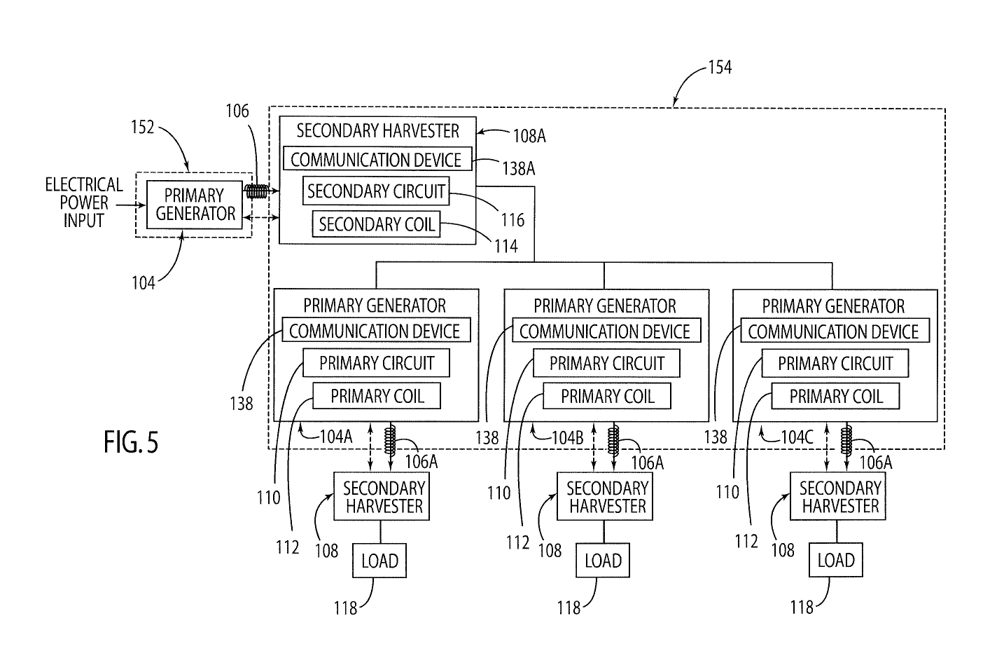

With respect to FIG. 5, the electrical power distribution system 100 can include the power source 102, and an outlet generally indicated at 152, according to one embodiment. Typically, the outlet 152 includes the primary generator 104 that emits the electromagnetic field 106. The electrical power distribution system 100 can further include an extension cord generally indicated at 154, wherein the extension cord 154 has a secondary harvester 108A that supplies the electrical power based upon receiving the electromagnetic field 106 when proximate to the primary generator 104 of the outlet 152. The extension cord 154 can further include at least one primary generator 104A in electrical communication with the secondary harvester 108A, such that the primary generator 104A emits an electromagnetic field 106A when the secondary harvester 108A receives the electromagnetic field 106 emitted from the primary generator 104, and supplies the electrical power to the primary generator 104A.

The load 118 can be in electrical communication with the secondary harvester 108, such that the secondary harvester 108 supplies the electrical power to the load 118 based upon the electromagnetic field 106A emitted by the primary generator 104A of the extension cord 154. Thus, the load 118 receives electrical power from the power source 102 (FIGS. 1 and 3) utilizing two inductive points of distribution, wherein the first inductive point of distribution is formed by the primary generator 104 and the secondary harvester 108A, and the second inductive point of distribution is formed by the primary generator 104A and the secondary harvester 108. It should be appreciated by those skilled in the art that any number of inductive points of distribution can be utilized between the power source 102 and the load 118 (FIGS. 1, 3, and 5).

According to one embodiment, the extension cord 154 can include a single primary generator 104A in electrical communication with the secondary harvester 108A, such that single load 118 is powered based upon the electromagnetic field 106A emitted from the primary generator 104A. According to an alternate embodiment, the extension cord 154 can include a plurality of primary generators 104A,104B,104C in electrical communication with the secondary harvester 108A, such that each of the plurality of primary generators 104A,104B,104C emit the electromagnetic field 106A based upon the electrical power supplied from the secondary harvester 108A. It should be appreciated by those skilled in the art that the extension cord 154 can include any number of primary generators 104A . . . 104_{N}, and is described as having three (3) primary generators 104A,104B,104C for purposes of explanation and not limitation.

Additionally, the secondary harvester 108A of the extension cord 154 includes the secondary communication device 138A, and the primary generator 104A of the extension cord 154 includes the primary communication device 138, such that the communication devices 138,138A can communicate a signal as to the electrical power requirements of the load, or addition or alternative information as described herein, through the extension cord 154. Thus, the secondary harvester 108A can communicate the information to the primary generator 104, such that any, or a combination thereof, of the primary generator 104,104A and the secondary harvesters 108,108A can control the supply of electrical power to the load 118, utilizing the respective controllers 128,128A. Additionally or alternatively, the information as to the load 118, such as the amount of electrical power requested by the load 118, can be communicated through the extension cord 154 to the system controller 139 (FIG. 3) such that the system controller 139 can control the supply of electrical power to the load 118.

As to FIGS. 1-3 and 5, the electrical power distribution system 100 can selectively supply the electrical power to one or more loads. According to one embodiment, one or more of the controllers 128,128A of the primary generator 104,104A and the secondary harvester 108,108A, respectively, can selectively control the amount of electrical power to one or more loads 118. Such an embodiment can generally be referred to as local selective control of the supplied electrical power.

Typically, the selective control of electrical power is based upon whether the power source 102 can supply the requested amount of electrical power, whether the primary generator 104,104A can adequately emit the electromagnetic field 106,106A, respectively, planned local requirements, the type of load, the like, or a combination thereof. Thus, selective control of electrical power can replace a standard fuse or circuit breaker, which is generally configured to prevent or stop the supply of electrical power if the circuit is shorted or the one or more loads 118 requests more power than can be supplied. Additionally, the selective control of electrical power can intelligently control the supply of electrical power, such that one or more loads 118 can continue to receive electrical power in circumstances that would otherwise cause a standard fuse or circuit breaker to break the circuit.

Additionally or alternatively, at least one attachment device 144,144A can selectively control the supply of electrical power utilizing the controller 128B, according to one embodiment. Thus, when the attachment device 144,144A selectively controls the supply of electrical power, the attachment device 144,144A typically selectively controls the supply of electrical power based upon more portions of the electrical power distribution system 100, when compared to when the primary generator 104,104A or the secondary harvester 108,108A selectively control the distribution power. Further, the system controller 139 can selectively control the supply of electrical power alone or in any combination with the attachment device 144,144A, the primary generator 104,104A, and the secondary harvester 108,108A.

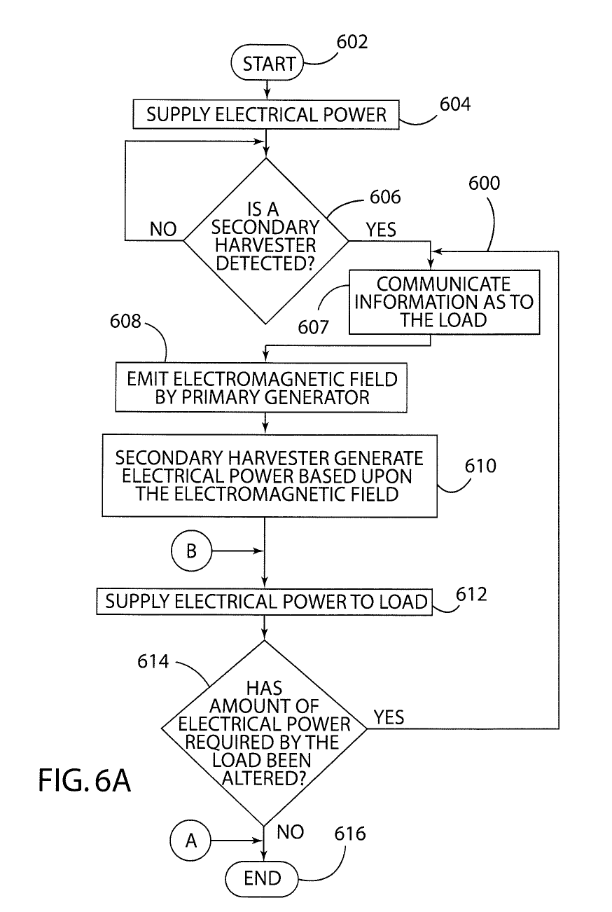

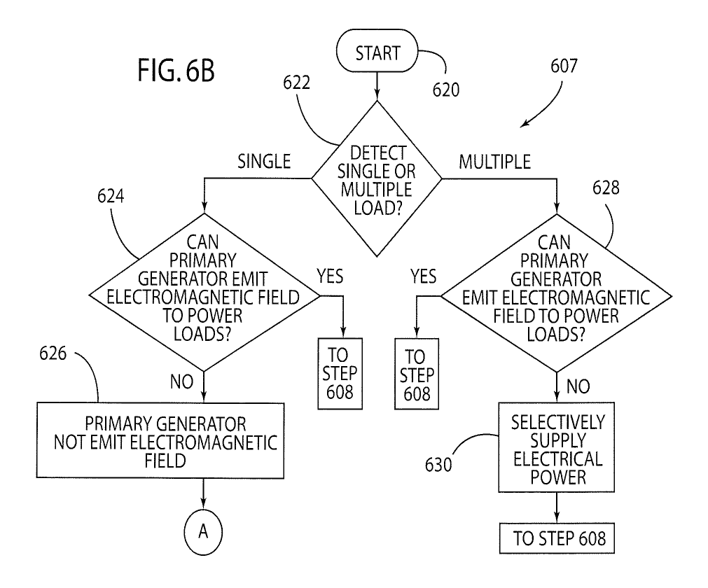

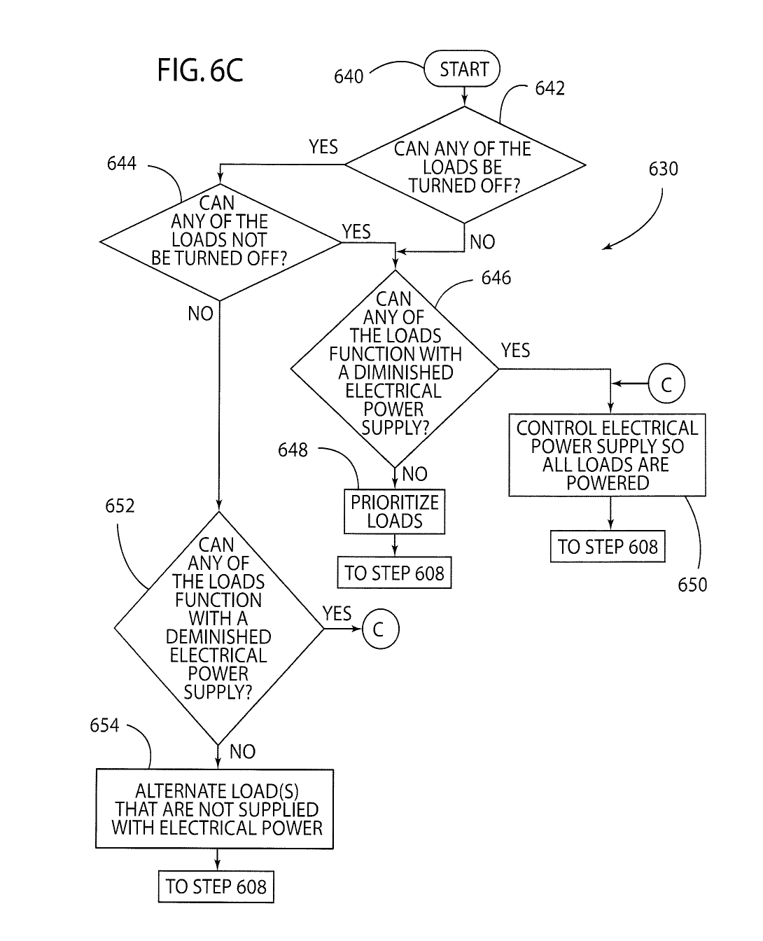

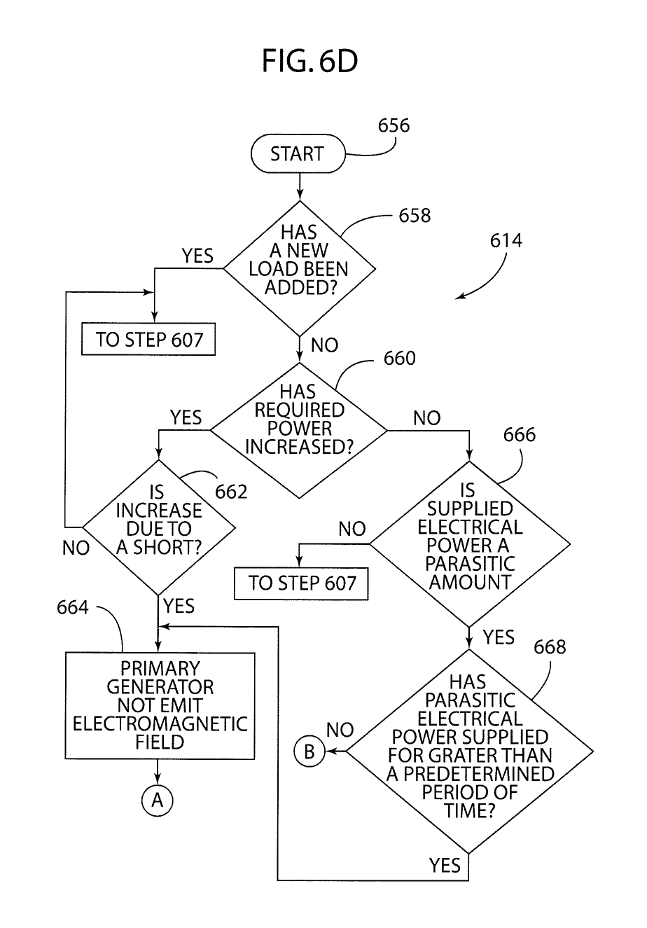

In regards to FIGS. 1-3, 5, and 6, a method of distributing electrical power is generally shown, particularly in FIG. 6, at reference identifier 600. The method 600 starts at step 602, and proceeds to step 604, wherein an electrical power is supplied. At decision step 606, it is determined if a secondary harvester 108 is detected. If it is determined at decision step 606 that a secondary harvester 108 is not detected, then the method 600 returns to decision step 606 to continuously monitor to see if a secondary harvester 108 can be detected. Typically, the primary generator 104 transmits signals periodically that powers the secondary harvester 108 and causes the secondary harvester to transmit a response signal to the primary generator 104, according to one embodiment (FIGS. 1-3). However, if it is determined at decision step 606 that a secondary harvester 108 is detected, then the method 600 proceeds to step 607. At step 607, the information as to the load 118 is communicated. The information as to the load 118 can include, but is not limited to, the electrical power required by the load 118, a planned local requirement, the like, or a combination thereof. At step 608, the electromagnetic field 106 is emitted by the primary generator 104. At step 610, the secondary harvester 108 generates an electrical power based upon the received electromagnetic field 106.

The method 600 then proceeds to step 612, wherein the electrical power is supplied to the load 118 by the secondary harvester 108. At decision step 614, it is determined if the amount of electrical power required by the load 118 has been altered. If it is determined at decision step 614 that the amount of electrical power required by the load 118 has not been altered, then the method 600 continues to supply electrical power to the load 118, and the method 600, then ends at step 616. However, if it is determined at decision step 614 that the amount of electrical power required by the load 118 has been altered, then the method returns to step 607.

With respect to FIG. 6B, the step of communicating information as to the load 118 is generally shown at reference identifier 607. Step 607 starts at step 620, and proceeds to decision step 622, wherein it is determined if a single or multiple loads 118 are detected. If it is determined at decision step 612 that a single load is detected, then the step 607 proceeds to decision step 624, wherein it is determined if a primary generator 104 can adequately emit the electromagnetic field 106 having an adequate magnetic flux to power the load 118. If it is determined at decision step 624 that the primary generator 104 can emit the electromagnetic field 106 to power the load 118, then the method 100 proceeds to step 608 (FIG. 6A). However, if it is determined at decision step 624 that the primary generator 104 cannot adequately emit the electromagnetic field 106 to power the load 118, then step 607 proceeds to step 626. At step 626, the primary generator 104 does not emit an electromagnetic field 106, and the method 600 then ends at step 616 (FIG. 6A).

When it is determined at decision step 622 that multiple loads 118 are present, then step 607 proceeds to decision step 628, wherein it is determined if the primary generator 104 can emit an adequate electromagnetic field 106 to power the multiple loads 118. If it is determined at decision step 628 that the primary generator 104 can emit the electromagnetic field 106 having an adequate magnetic flux to power the multiple loads 118, then the method 600 proceeds to step 608 (FIG. 6A). However, if it is determined at decision step 628 that the primary generator 104 cannot adequately emit the electromagnetic field 106 to power the loads 118, then the step 607 proceeds to step 630. At step 630, the electrical power supplied to the multiple loads 118 is selectively supplied, and the method 600 proceeds to step 608 (FIG. 6A).

In regards to FIG. 6C, the step of selectively supplying electrical power is generally shown at reference identifier 630. The step 630 starts at step 640, and proceeds to decision step 642, wherein it is determined that if any of the loads 118 can be turned off. If it is determined at decision step 642 that any, or at least one, of the loads 118 can be turned off, then the step 630 proceeds to decision step 644, wherein, it is determined if any one of the loads 118 cannot be turned off. If it is determined at decision step 644 that any of the loads 118 cannot be turned off, or it is determined at decision step 642 that none of the loads 118 can be turned off, then the step 630 proceeds to decision step 646.

At decision step 646 it is determined if any of the loads 118 can function with a diminished electrical power supply. If it is determined at decision step 646 that none of the loads 118 can function with a diminished electrical power supply, then the step 630 proceeds to step 648, wherein the loads 118 are prioritized, and the method 600 proceeds to step 608 (FIG. 6A). According to one embodiment, prioritizing the loads 118 can include making the determination that one or more loads 118 cannot be turned off, or it is desired that the load 118 not be turned off (e.g., the load 118 is a life-support apparatus), while other loads 118 can be turned off, or that it is acceptable to turn off such a load 118 (e.g., the load is a television). Thus, when it is determined that one or more of the loads 118 can be turned off, then it is determined what loads 118 are to be turned off in order for an adequate amount of electrical power to be supplied to the one or more loads 118 that are to continue to receive electrical power.

When it is determined at decision step 646 that any of the loads 118 can function with a diminished electrical power supply, then the step 630 proceeds to step 650, wherein the electrical power supplied to all the loads 118 is controlled by diminishing or reducing the amount of electrical power supplied to the loads 118. According to one embodiment, by diminishing the amount of electrical power supplied to the loads 118 results in the load 118 operating differently, such as when the load 118 are light sources, the light sources emit a diminished or reduced amount of illumination. Typically, if it is determined that any of the loads 118 can function at a diminished electrical power at decision step 646, then only those loads 118 that have such capability are supplied with the diminished amount of electrical power at step 650, while other loads 118 that do not have such capability continue to be supplied with requested amount of electrical power. The method 600 then proceeds to step 608 (FIG. 6A).

However, if it is determined at decision step 644 that none of the loads 118 can be turned off, then the step 630 proceeds to decision step 652, wherein it is determined if any of the loads 118 can function with a diminished electrical power supply. If it is determined at decision step 652 that any of the loads 118 can function with a diminished electrical power supply, then step 630 proceeds to step 650. When it is determined at decision step 652 that none of the loads 118 can function with a diminished electrical power supply, then the step 630 proceeds to step 654, wherein the loads 118 that are not supplied with the electrical power are alternated, and the method 600 proceeds to step 608 (FIG. 6A). According to one embodiment, when the loads 118 are alternatingly being turned off, the combination of loads 118 to be turned off in order for an adequate mount of electrical power to be supplied to the remaining one or more loads 118 is determined. Then the determined combinations of one or more loads 118 are alternatingly turned off during periodic time intervals. In such an embodiment the loads 118 can be freezers, and the periodic time intervals (i.e., the time period the load 118 is turned off) can be based upon the time the freezers can be turned off while maintaining a desired temperature.

As to FIG. 6D, the decision step of determining if an amount of electrical power required by the load 118 has been altered is generally shown at reference identifier 614. The step 614 starts at step 656, and proceeds to decision step 658, wherein it is determined if a new load 118 has been added. If it is determined at decision step 658 that a new load 118 has been added, then the method 600 proceeds to step 607 (FIG. 6A). However, if it is determined at decision step 658 that a new load 118 has not been added, then the step 614 proceeds to decision step 660, wherein it is determined if the amount of electrical power required by the loads 118 has increased.

If it is determined at decision step 660 that the required electrical power to the loads 118 has increased, then the step 614 proceeds to decision step 662, wherein it is determined if the increase in required electrical power is due to a short. If it is determined at decision step 662, that the increase in electrical power required is not due to a short, than the method 600 proceeds to step 607 (FIG. 6A). When it is determined at decision step 662 that the increase in electrical power is due to a short, then the step 614 proceeds to step 664, wherein the primary generator 104 does not emit the electromagnetic field 106, and the method 600 then ends at step 616 (FIG. 6A). In such an embodiment, the primary generator 104 replicates a standard fuse or circuit breaker that stops or prevents the supply of electrical power when a short circuit is detected.

When it is determined at decision step 660 that the amount of electrical power required has not increased, then the step 614 proceeds to decision step 666, wherein it is determined if the amount of electrical power to be supplied is a parasitic amount of electrical power. If it is determined at decision step 666 that the amount of electrical power being supplied is not a parasitic amount, then the method 600 proceeds to step 607. However, if it is determined at decision step 666 that the amount of electrical power being supplied is a parasitic amount, then the step 614 proceeds to decision step 668, wherein it is determined if the parasitic amount of electrical power is supplied for greater than a predetermined period of time.

If it is determined at decision step 668 that the parasitic amount of electrical power has been supplied for greater than a predetermined period of time, then the step 614 proceeds to step 664, wherein the primary generator does not emit the electromagnetic field 106. When it is determined at decision step 668, that the parasitic amount of electrical power being supplied has not been supplied for greater than the predetermined period of time, then the method 600 proceeds to step 612 (FIG. 6A).

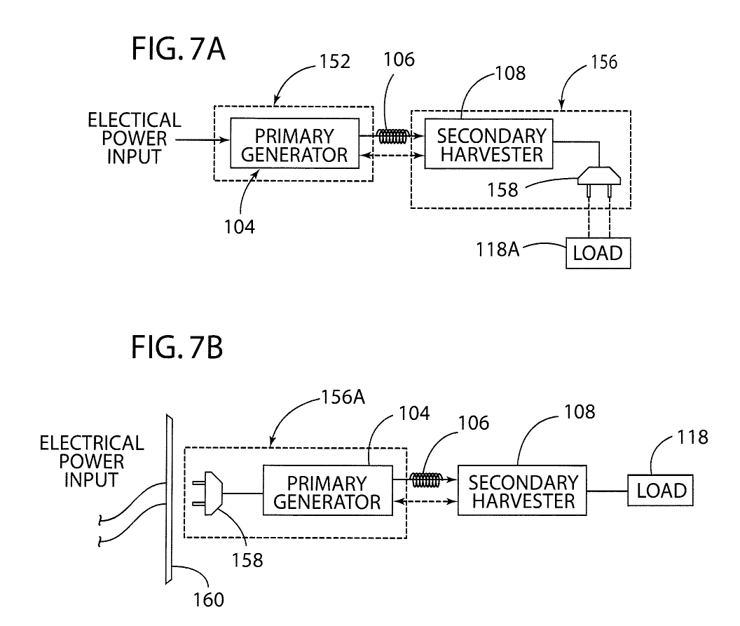

In regards to FIG. 7A an adapter is generally shown at 156, wherein the adapter includes a secondary harvester 108 and a standard plug 158 (e.g., two or three prong plug). In such an embodiment, the adapter 156 supplies electrical power that is transmitted over the standard plug 158 to a load 118A. Typically, the secondary harvester 108 receives the electromagnetic field 106, and supplies the electrical power to the load 118A through the standard plug 158. By way of explanation and not limitation, the load 118A can be a standard device that is powered with a voltage potential of one hundred twenty volts (120V) or two hundred forty volts (240V). Thus, the electrical power distribution system 100 can be used to power the standard load 118A. In such an embodiment, the secondary harvester 108 can include the communication device 138A, such that the secondary harvester 108A can communicate that the load 118A is going to be supplied with the form of electrical power that is typically supplied when utilizing the specific type of plug interface 158 (e.g., the plug interface 158 is a standard one hundred twenty volts (120V) or two hundred forty volts (240V) plug interface).

According to an alternate embodiment, as shown in FIG. 7B, an adapter generally indicated at 156A, can include the standard plug 158 and a primary generator 104. Typically, the standard plug 158 is plugged into a standard outlet 160, such that electrical power is propagated over at least two electrical conductors (e.g., electrical power having a voltage potential of one hundred twenty volts (120V) or two hundred forty volts (240V)). The electrical power is supplied to the primary generator 104 that emits the electromagnetic field 106. The secondary harvester 108 receives the electromagnetic field 106 and supplies an electrical power to the load 118. The primary generator 104 and secondary harvester 108 can communicate as described above, wherein the maximum flux of the electromagnetic field 106 is known based upon the form of electrical power that is typically supplied when utilizing the specific type of plug interface 158 (e.g., the plug interface 158 is a standard one hundred twenty volts (120V) or two hundred forty volts (240V) plug interface), according to one embodiment.

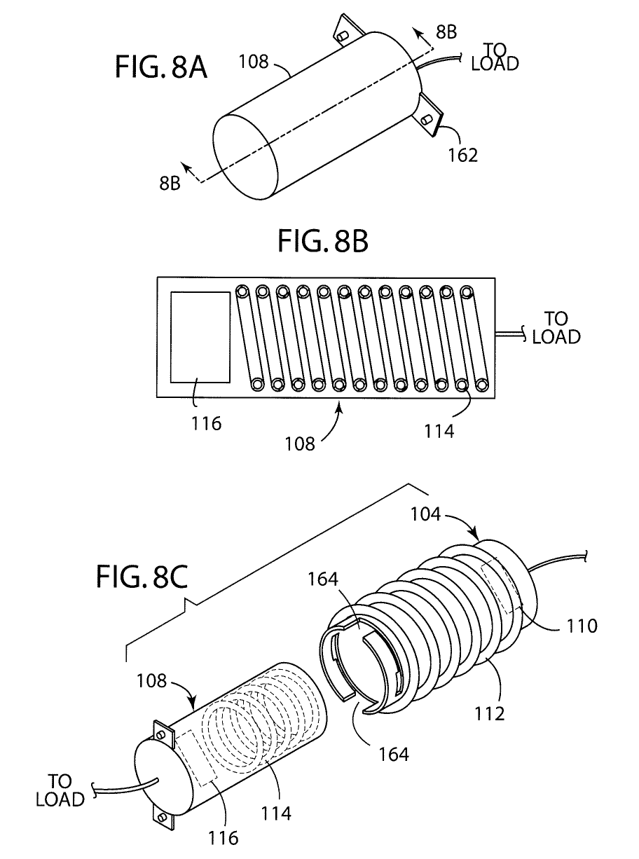

According to one embodiment, the secondary harvester 108 is removable, such that the locational relationship between the primary generator 104 and the secondary harvester 108 can be altered, so that the secondary harvester 108 can be located to receive the emitted electromagnetic field 106 (i.e., proximate to the primary generator 104) or located to not receive the emitted electromagnetic field 106 (i.e., not proximate the primary generator 104). According to one embodiment, as illustrated in FIG. 8A, the secondary harvester 108 can be a cylindrical shape having at least one radial extension 162 extending from an end of the secondary harvester 108, such that when the secondary harvester 108 is proximate to the primary generator 104 and capable of receiving the emitted electromagnetic field 106, at least a portion of the secondary harvester 108 is received by the primary generator 104.

As shown in FIG. 8C, the primary generator 104 includes one or more receptacles 164 that are adapted to receive the one or more extensions 162 of the secondary harvester 108. Thus, when the secondary harvester 108 is placed proximate to the primary generator 104, the receptacles 164 receive the extensions 162, and the secondary harvester 108 can then be rotated, such as, but not limited to, a quarter turn, in order to adequately secure the secondary harvester 108 to the primary generator 104. Additionally, having such an interlocking mechanism between the primary generator 104 and the secondary harvester 108, enhance in the alignment of the primary coil 112, and the secondary coil 114 to enhance in the emittance and reception of the electromagnetic field 106.

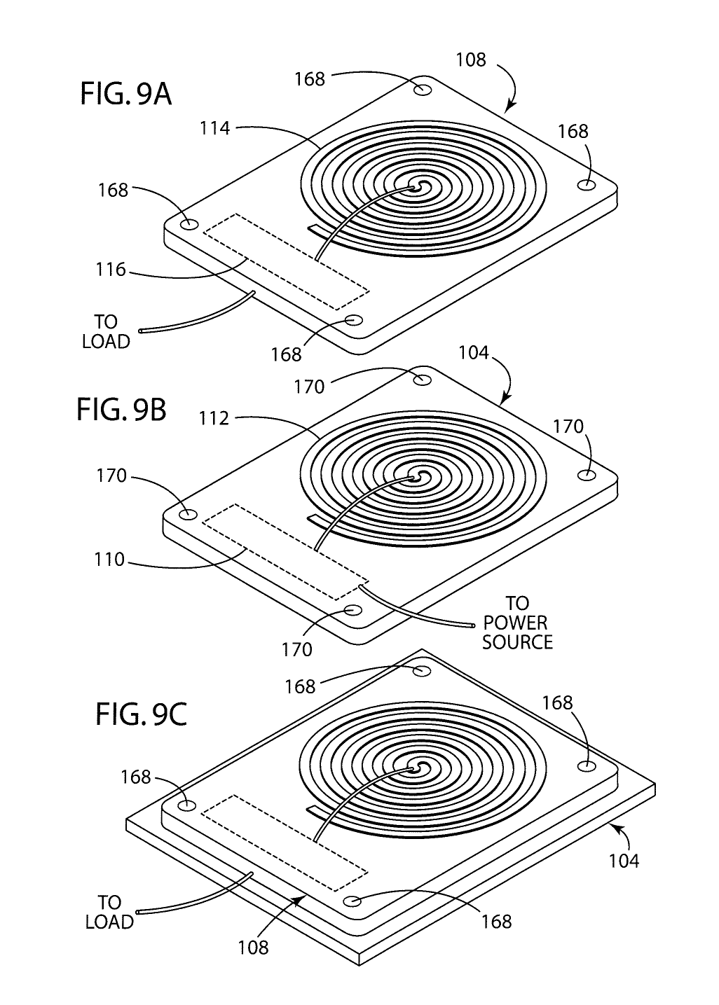

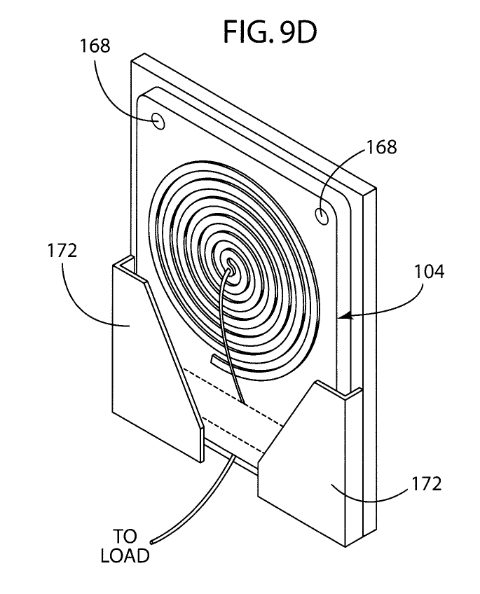

According to an alternate embodiment, as shown in FIGS. 9A-9D, the secondary harvester 108 can include at least one magnet 168 that corresponds to at least one magnet 170 located on the primary generator 104. Additionally, the primary generator 104 and the secondary harvester 108 are shaped having a flat, plate surface that includes the corresponding magnets 168,170, such that when the plate surfaces of the primary generator 104 and the secondary harvester 108 contact one another, the magnets 168,170 attract to secure and align the secondary harvester 108 with the primary generator 104, as shown in FIG. 9C. Thus, the attraction of the magnets 168,170 secure the secondary harvester 108 to the primary generator 104, while assisting the alignment of the primary coil 112 and the secondary coil 114. In such an embodiment, the primary generator 104 can be integrated on a flat surface, such as, but not limited to, a wall, a floor, a table, a shelf, or the like.

Additionally, as shown in FIG. 9D, the primary generator 104 can include one or more mechanical attachment devices 172 that mechanically interlock with the secondary harvester 108, which assists in securing and aligning the secondary harvester 108 with the primary generator 104. Thus, if the primary generator 104 is in a vertical position, the secondary harvester 108 can be placed between the surface of the primary generator 104 and the mechanical attachment to the secondary harvester 108 secure the secondary harvester 108 to the primary generator 104 utilizing the mechanical attachment device 172.

The following paragraphs are part of the description of the invention.

1. An electrical power distribution system comprising:
a primary generator comprising:

a primary coil configured to emit an electromagnetic field when an electrical power is supplied to said primary coil; and

a first communication device configured to communicate a signal; and
a secondary harvester comprising:

a secondary coil configured to supply an electrical power when receiving said emitted electromagnetic field; and

a second communication device configured to communicate said signal, such that said first and second communication devices communicate said signal independent from said emitted electromagnetic field.

2. An electrical power distribution system comprising:
a primary generator comprising:

a primary coil configured to emit an electromagnetic field when an electrical power is supplied to said primary coil; and

a first communication device configured to communicate a signal; and
a secondary harvester comprising:

a secondary coil configured to supply an electrical power when receiving said emitted electromagnetic field; and

a second communication device configured to transmit said signal, such that said first and second communication devices wirelessly communicate said signal as to power requirements of a load independent of said emitted electromagnetic field.

3. An electrical power distribution system comprising:
an attachment device configured to receive a first electrical power and supply a second electrical power, wherein said supplied second electrical power is based upon load requirements communicated from at least one load to said attachment device; and

a controller in communication with said attachment device, and configured to command said attachment device to supply said second electrical power.

4. An electrical power distribution system comprising:
a plurality of attachment devices, at least a portion of which are configured to receive a first electrical power and supply a second electrical power that is based upon load requirements communicated from a first load to said at least a portion of said plurality of attachment devices; and
a system controller in communication with at least a portion of said plurality of attachment devices, and configured to control said supply of said second electrical power.

5. An electrical power distribution system comprising:
a primary generator configured to emit an electromagnetic field when a first electrical power is supplied to said primary generator;
a secondary harvester configured to supply a second electrical power when proximate said primary generator and said electromagnetic field emitted from said primary generator is received; and
a controller in communication with one of said primary generator and said secondary harvester, and configured to control said supply of said second electrical power by said secondary harvester.

6. A method of distributing electrical power, said method comprising the steps of:
receiving a first electrical power having a first distribution characteristic by a converter;
altering said first distribution characteristic of said first electrical power by said converter;
supplying a second electrical power having a second distribution characteristic different than said first distribution characteristic from said converter; and
supplying a third electrical power having a third distribution characteristic different than said first and second distribution characteristics from said converter.

7. A method of distributing electrical power, said method comprising the steps of:
receiving a first electrical power supplied at a first frequency by a converter;
altering said first frequency to a second frequency and a third frequency by said converter;
supplying a second electrical power having said second frequency from said converter; and
supplying a third electrical power having said third frequency from said converter.

8. An extension cord comprising:
a secondary harvester comprising:
a secondary coil configured to supply an electrical power when a first electromagnetic field is received; and
a secondary communication device configured to communicate a signal; and
at least one primary generator in electrical communication with said secondary harvester by at least one electrical conductor, and comprising:
a primary coil configured to emit a second electromagnetic field based upon said electrical power supplied by said secondary harvester; and
a primary communication device configured to communicate said signal as to electrical power requirements of at least one load.

9. A method of distributing electrical power, said method comprising the steps of:
emitting an electromagnetic field by a primary generator when said primary generator receives a an electrical power;
receiving said emitted electromagnetic field by a secondary harvester;
receiving electrical power requirements of at least one load by said secondary harvester; and
selectively supplying said electrical power by said secondary harvester to said at least one load.

10. An adaptor comprising:
a secondary harvester configured to supply an electrical power when an electromagnetic field is received; and
a plug interface adapted to receive at least two electrical conductors, such that said electrical power supplied by said secondary harvester is propagated over said at least two electrical conductors.

11. An adaptor comprising:
a plug interface adapted to receive at least two electrical conductors that propagate electrical power; and
a primary generator configured to emit an electromagnetic field when said primary generator receives said electrical power that is propagated over said at least two electrical conductors.

The above paragraphs are part of the description of the invention.

Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

What is claimed is:

1. A power distribution system comprising:
a load having load requirements, the load requirements include a time based schedule of use;
a primary generator having a primary circuit, a primary communication device, and a primary coil, the primary coil emits an electromagnetic field, the primary circuit controlling characteristics of the electromagnetic field according to received power from a power source and the load requirements;
a secondary harvester having a secondary circuit, a secondary communication device and a secondary coil, the secondary coil receives the emitted electromagnetic field, the secondary circuit determines the load requirements of the load and provides power to the load that meets the load requirements, the secondary communication device communicates the load characteristics to the primary communication device of the primary generator; and
a system controller coupled to the primary generator and the secondary harvester.

2. The system of claim 1, wherein the secondary communication device communicates with the primary communication device independent of the electromagnetic field.

3. The system of claim 1, wherein the load is one or more of an enhanced outlet, an extension cord, a power distributor, and an inductive device.

4. The system of claim 1, wherein the received power is AC power.

5. The system of claim 1, wherein the primary generator receives power at a voltage greater than 220 volts.

6. The system of claim 1, wherein the secondary harvester generates AC power.

7. The system of claim 1, wherein the secondary harvester generates DC power.

8. The system of claim 1, further comprising a second primary generator that receives power from the secondary harvester, the second primary generator emits a second electromagnetic field.

9. The system of claim 8, further comprising an additional secondary harvester that receives the emitted second electromagnetic field.

10. The system of claim 9, further comprising a second load that receives power from the additional secondary harvester.

11. A power distribution system comprising:
an attachment device to receive a first electrical power and supply a second electrical power, the supplied electrical power is based upon load requirements communicated from at least one load to the attachment device;
the attachment device includes a secondary harvester having a secondary circuit, a secondary communication device and a secondary coil, the secondary coil receives the first electrical power;
a controller in communication with the attachment device, and configured to command the attachment device to supply the second electrical power; and
a plurality of additional attachment devices, one of the plurality of additional attachment devices configured to receive the first electrical power and supply a third electrical power.

12. The system of claim 11, further comprising a high voltage distribution that provides the first electrical power.

13. The system of claim 12, wherein the high voltage distribution receives a power input at a lower voltage than the provided first electrical power.

14. A method of distributing electrical power, said method comprising the steps of:
receiving a first electrical power having a first distribution characteristic by a converter;
altering said first distribution characteristic of said first electrical power by said converter;
supplying a second electrical power having a second distribution characteristic different than said first distribution characteristic from said converter; and
supplying a third electrical power having a third distribution characteristic different than said first and second distribution characteristics from said converter.

15. The method of claim 14, wherein the first distribution characteristic includes a first frequency and the second distribution characteristic includes a second frequency different than the first frequency.

16. The method of any one of claim 15, wherein the first distribution characteristic includes a first voltage and the second distribution characteristic includes a second voltage varied from the first voltage.
